(19) United States
(12) Patent Application Publication
(10) Pub. No.: US 2012/0242300 A1
(43) Pub. Date: Sep. 27, 2012

(54) DC-DC CONVERTER CONTROL APPARATUS AND DC-DC CONVERTER

(75) Inventors: Takeshi Ueno, Kawasaki-shi (JP); Akio Kuroda, Kawasaki-Shi (JP)

(73) Assignee: KABUSHIKI KAISHA TOSHIBA, Tokyo (JP)

(21) Appl. No.: 13/234,543

(22) Filed: Sep. 16, 2011

(30) Foreign Application Priority Data
Mar. 24, 2011 (JP) 2011-65933

(51) Int. Cl. G05F 1/46

(52) U.S. Cl. 323/234

(57) ABSTRACT

A DC-DC converter control apparatus controls a DC-DC converter which has an inductor connected between an input terminal for a direct-current input voltage and an output terminal for a direct-current output voltage obtained by converting the direct-current input voltage, a capacitor connected to the inductor, and a switch configured to switch whether the direct-current input voltage is applied to the inductor. The DC-DC converter control apparatus has a subtractor configured to generate a differential voltage between the direct-current input voltage and a reference voltage, a comparator configured to generate a determining signal that indicates determination of a polarity of the differential voltage, and a delay part configured to delay the determining signal for a specific delay time.

### CROSS REFERENCE TO RELATED APPLICATIONS

This application is based upon and claims the benefit of priority from the prior Japanese Patent Application No. 2011-65933, filed on Mar. 24, 2011, the entire contents of which are incorporated herein by reference.

### FIELD

Embodiments of the present invention relate to a DC-DC converter control apparatus and a DC-DC converter for converting a direct-current input voltage to a direct-current output voltage.

### BACKGROUND

Self-excited DC-DC converters without using external clocks have advantages, as follows. Since the self-excited DC-DC converters do not have restriction on operating speed by clock frequencies, they exhibit a quick response to load variation. Moreover, since the self-excited DC-DC converters do not require a circuit for generating PWM (Pulse Width Modulation) signals and a compensator for phase compensation, they can be fabricated at a smaller circuit scale.

However, since the self-excited DC-DC converters don not use external clocks, a switching frequency has to be controlled. A known control technique is to control a hysteresis band of a comparator used in a control circuit. The switching frequency fsw in this case is expressed by the following expression (1).

$${f}_{sw} = \frac{{V}_{out} ( 1 - \frac{{V}_{out}}{{V}_{i n}} )}{2 kL} \qquad ( 1 )$$

Here, Vin and Vout are input and output voltages of a DC-DC converter, respectively, k is a hysteresis band of a comparator, and L is inductance.

According to the expression (1), it is understood that the switching frequency is controlled by adjusting the hysteresis band k of a comparator.

However, the inductance L is one of the parameters for determining the switching frequency fsw. Therefore, it is impossible to obtain a desired switching frequency fsw if the inductance L is not known.

In general, an inductor used in a DC-DC converter is provided separately from a control circuit IC of the DC-DC converter. Therefore, it is difficult to know the inductance of the inductor in a design stage for the control circuit IC. Moreover, even if an approximate inductance value of the inductor has already been known, the value varies due to variations in manufacture, aging, etc., thus resulting in errors in the switching frequency fsw.

As a technique for solving this problem, a feedback loop may be provided for adjusting a hysteresis band while observing a switching frequency fsw. Such a feedback loop may automatically adjust a hysteresis band k to an appropriate value even if the inductance L is not known. However, a DC-DC converter originally has a feedback loop (a first loop, hereinbelow) for stabilizing the output voltage. Therefore, in order to adopt the technique, a DC-DC converter has to be provided with another feedback loop (a second loop, hereinbelow) for adjusting a hysteresis band for stabilizing the switching frequency fsw described above, in addition to the first loop.

The second loop requires a frequency band extremely lower than the first loop so as not to affect the first loop, thus suffering from a low response speed.

### BRIEF DESCRIPTION OF THE DRAWINGS

FIG. 1 is a schematic circuit diagram of a DC-DC converter 1 according to a first embodiment;

FIG. 2 is a view showing a voltage waveform of a ripple component of a direct-current output voltage Vout;

FIG. 3 is a schematic circuit diagram of a DC-DC converter 1 according to a second embodiment;

FIG. 4 is a schematic circuit diagram of a DC-DC converter 1 according to a third embodiment;

FIG. 5 is a circuit diagram of a DC-DC converter 1 according to a fourth embodiment;

FIG. 6 is a block diagram schematically showing the configuration of a delay part 7 according to a fifth embodiment;

FIG. 7 is a block diagram showing an example of the detailed configuration of a delay element DS1;

FIG. 8 is a block diagram schematically showing the configuration of a delay part 7 according to a sixth embodiment; and

FIG. 9 is a block diagram schematically showing the configuration of a delay part 7 according to a seventh embodiment.

### DETAILED DESCRIPTION

Embodiments will now be explained with reference to the accompanying drawings.

A DC-DC converter control apparatus controls a DC-DC converter which has an inductor connected between an input terminal for a direct-current input voltage and an output terminal for a direct-current output voltage obtained by converting the direct-current input voltage, a capacitor connected to the inductor, and a switch configured to switch whether the direct-current input voltage is applied to the inductor. The DC-DC converter control apparatus has a subtractor configured to generate a differential voltage between the direct-current output voltage and a reference voltage, a comparator configured to generate a determining signal that indicates determination of a polarity of the differential voltage, and a delay part configured to delay the determining signal for a specific delay time. The switch is turned on or off based on the determining signal delayed by the delay part, and the specific delay time is decided by the direct-current input voltage, the reference voltage and a frequency for turning on or off the switch.

### First Embodiment

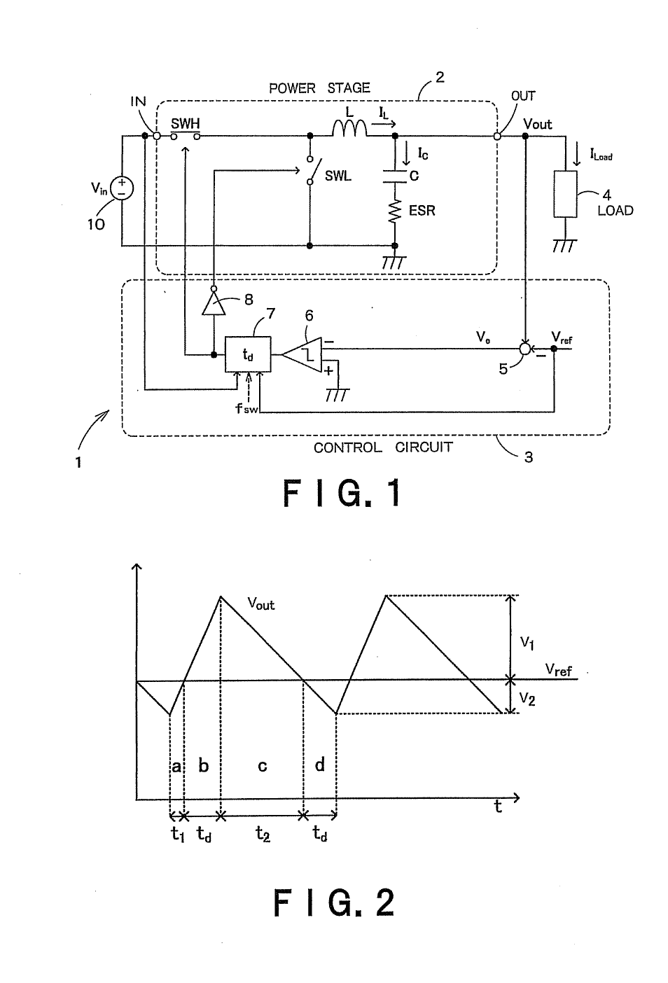

FIG. 1 is a schematic circuit diagram of a DC-DC converter 1 according to a first embodiment. The DC-DC converter 1 of FIG. 1 is provided with a power stage 2 (a direct-current converting part) for stepping down a direct-current input voltage Vin to a direct-current output voltage Vout and a control circuit 3 for controlling the power stage 2. The power stage 2 has a high-side switch SWH, a low-side switch SWL, an inductor L, a smoothing capacitor C, and a parasitic register ESR of the smoothing capacitor C. The control circuit 3 corresponds to a DC-DC converter control apparatus.

Connected to an input terminal IN and an output terminal OUT of the power stage 2 are a power supply 10 and a load 4, respectively. The high-side switch SWH and the inductor L are connected in series between the power supply 10 and the load 4. Between the output terminal OUT and a ground terminal of the power stage 2, the smoothing capacitor C and the parasitic resister ESR are connected in series. The low-side switch SWL is connected at one end to a connection path of the high-side switch SWH and the inductor L, and connected at the other end to the ground terminal.

The control circuit 3 has a subtractor 5 for generating a differential voltage between the direct-current output voltage Vout and a reference voltage Vref, a comparator 6 for determining the polarity of the differential voltage to output a determining signal, a delay part 7 for delaying the determining signal for a specific delay time, and an inverter 8 for inverting the determining signal delayed by the delay part 7. A switch control signal output from the delay part 7 is used for on/off switching of the high- and low-side switches SWH and SWL. The high-side switch SWH and the low-side switch SWL are alternately turned on and off.

The delay time of the delay part 7 is decided from the direct-current input voltage Vin, the reference voltage Vref, and an on/off frequency (a switching frequency) for turning on/off the high- and low-side switches SWH and SWL.

If the reference voltage Vref is higher than the direct-current output voltage Vout, the subtractor 5 outputs a negative differential voltage, hence the comparator 6 outputs a high-level determining signal that indicates the negative polarity. The high-level determining signal causes the high-side switch SWH to turn on (to close the path) but causes the low-side switch SWL to turn off (to open the path), thus increasing the direct-current output voltage Vout. Conversely, if the direct-current output voltage Vout is higher than the reference voltage Vref, the subtractor 5 outputs a positive differential voltage, hence the comparator 6 outputs a low-level determining signal that indicates the positive polarity. The low-level determining signal causes the high-side switch SWH to turn off but causes the low-side switch SWL to turn on, thus decreasing the direct-current output voltage Vout.

Here, it is supposed that a current Iload to be supplied to the load 4 is almost constant, that is, the current Iload carries only a direct current component. In this case, a capacitor current Ic is equal to a ripple component of an inductor current IL of the inductor L. The smoothing capacitor C has the parasitic resister ESR. The resistance of the parasitic resister ESR is denoted as ESR. If an electrolytic capacitor is used as the smoothing capacitor C, the parasitic resister ESR is much greater than the impedance of the smoothing capacitor C at the switching frequency fsw, in most cases. Accordingly, the following expression (2) is established.

$$\vert \frac{1}{j 2 π {f}_{sw} C} \vert << ESR \qquad ( 2 )$$

With the expression (2) given as above, the ripple component of the direct-current output voltage Vout can be calculated from the inductor current IL and the parasitic resistance ESR.

FIG. 2 is a view showing a voltage waveform of the ripple component of the direct-current output voltage Vout. In FIG. 2, the abscissa and the ordinate represent time and voltage, respectively. The ripple component of the direct-current output voltage Vout has cycles in accordance with the switching frequency fsw. One cycle is divided into four periods a, b, c, and d, as shown.

In the period a, the direct-current output voltage Vout is smaller than the reference voltage Vref. Therefore, the comparator 6 outputs a high-level determining signal to turn on the high-side switch SWH and turn off the low-side switch SWL. In this period, the direct-current output voltage Vout linearly increases.

The determining signal output from the comparator 6 changes from a high to a low level at the moment of Vout=Vref. However, there is a time difference between the determining signal output from the comparator 6 and the switch control signal output from the inverter 8, that is a delay time at the delay part 7. Accordingly, an on-state of the high-side switch SWH and an off-state of the low-side switch SWL continue for the period b.

When a delay time td elapses after the period a changes to the period b, the high- and low-side switches SWH and SWL are turned off and on, respectively, with the transition to the period c. The direct-current output voltage Vout linearly decreases in the period c.

Thereafter, when the direct-current output voltage Vout comes to be equal to the reference voltage Vref again, the determining signal output from the comparator 6 changes to the high level. However, due to the delay time at the delay part 7, the high- and low-side switches SWH and SWL remain turned off and on, respectively. Therefore, the direct-current output voltage Vout continues to decrease. This is the period d that continues for a time td.

When a differential voltage between the maximum value of the direct-current output voltage Vout and the reference voltage Vref is denoted as V1 and a differential voltage between the minimum value of Vout and Vref is denoted as V2, with lengths t1 and t2 for the periods a and c, respectively, the following expressions (3) to (6) are established.

$$\begin{matrix}{V}_{2} = \frac{{V}_{i n} - {V}_{out}}{L} {t}_{1} \times ESR & ( 3 ) \\ {V}_{1} = \frac{{V}_{i n} - {V}_{out}}{L} {t}_{d} \times ESR & ( 4 ) \\ - {V}_{1} = - \frac{{V}_{out}}{L} {t}_{2} \times ESR & ( 5 ) \\ - {V}_{2} = - \frac{{V}_{out}}{L} {t}_{d} \times ESR & ( 6 )\end{matrix}$$

When t1 and t2 are given with the expressions (3) to (6), the following expressions (7) and (8) are given.

$$\begin{matrix}{t}_{1} = \frac{{V}_{out}}{{V}_{i n} - {V}_{out}} {t}_{d} & ( 7 ) \\ {t}_{2} = \frac{{V}_{i n} - {V}_{out}}{{V}_{out}} {t}_{d} & ( 8 )\end{matrix}$$

As shown in FIG. 2, since one cycle is (t1+td+t2+td), the switching frequency fsw is expressed by the flowing expression (9).

$${f}_{sw} = \frac{1}{{t}_{1} + {t}_{d} + {t}_{2} + {t}_{d}} = \frac{( {V}_{i n} - {V}_{out} ) {V}_{out}}{{V}_{i n}^{2}} \times \frac{1}{{t}_{d}} \qquad ( 9 )$$

It is understood that when direct-current input and output voltages Vin and Vout are given, a delay time td to obtain a desired switching frequency fsw can be uniquely decided from the expression (9) only. In the DC-DC converter 1, the direct-current output voltage Vout is controlled to be equal to the reference voltage Vref, hence Vout may be replaced with Vref in the expression (9).

FIG. 1 is a circuit for realizing an expression obtained by replacing Vout with Vref. To the delay part 7 in the control circuit 3 of FIG.1, the determining signal from the comparator 6 depending on (Vin−Vref), the direct-current input signal Vin, and the reference voltage Vref are input as input signals. The switching frequency fsw may also be input in some cases. The switching frequency fsw may be preset to a desired value at the delay part 7, instead of being externally input.

Based on these signals, the delay part 7 obtains a delay time td based on the expression (9) described above to delay the determining signal from the comparator 6 for the obtained delay time td and output a delayed determining signal.

By providing the delay part 7 as above, the timing of switching between the high- and low-side switches SWH and SWL can be shifted for the delay time td to superpose a ripple component on the direct-current output voltage Vout, as shown in FIG. 2.

In the case of inputting a desired switching frequency fsw from outside to the delay part 7 of FIG. 1, a delay time td is obtained by the expression (9), using an externally set switching frequency fsw, a direct-current input voltage Vin, a direct-current output voltage Vout (or a reference voltage Vref), as parameters. Different from this, a delay time td may be obtained using a table that is a list of switching frequencies fsw, direct-current input voltages Vin, and direct-current output voltages Vout, as input parameters, and the corresponding delay times td. That is, when the input parameters are given, the table is looked-up to search for the corresponding delay time td.

As described above, according to the first embodiment, the high- and low-side switches SWH and SWL are alternately turned on and off by a switching control signal obtained by delaying the determining signal for a specific delay time td, that indicates the positive or negative polarity depending on the differential voltage between the direct-current output voltage Vout and the reference voltage Vref. Therefore, even if an inductance L of the inductor L is unknown, the switching frequency fsw can be accurately controlled using the delay time td.

### Second Embodiment

It is a precondition in a second embodiment that the smoothing capacitor C has a small parasitic resistor ESR.

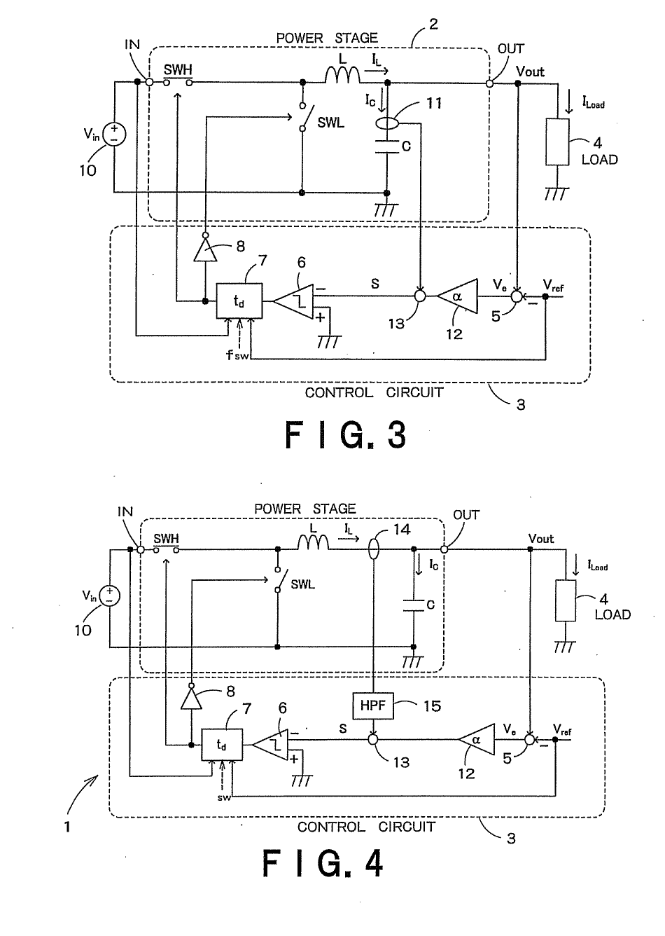

FIG. 3 is a schematic circuit diagram of a DC-DC converter 1 according to the second embodiment. In FIG. 3, the elements common to FIG. 1 are given the same reference signs or numerals. Hereinbelow, the different points will be mainly explained.

When a capacitor C, such as a ceramic capacitor, having a small parasitic resistor ESR is used as the smoothing capacitor C, it is often happened that the expression (2) described above is not established. Therefore, a ripple waveform such as shown in FIG. 2 cannot be observed when the output voltage is merely observed. Accordingly, the DC-DC converter 1 of FIG. 3 has a capacitor-current detecting part 11 for detecting a capacitor current that flows through the smoothing capacitor C, an amplifier 12 for multiplying a differential voltage output from the subtractor 5 by a gain, and an adder 13 for adding an output signal of the amplifier 12 and that of the capacitor-current detecting part 11.

A signal S that is a result of addition at the adder 13 is expressed by the following expression (10).

S=α(Vout−Vref)+Ic (10)

In the expression (10), if a gain is set to give an inequality α(Vout−Vref)<<Ic, a waveform of the input signal of the comparator 6 becomes similar to that of FIG. 2, hence the expression (9) obtained for the periods a, b, c, and d in FIG. 2 is established as it is. Accordingly, also in the second embodiment, a desired switching frequency fsw can be decided using a delay time td, like the first embodiment.

In the expression (10), the capacitor current Ic has a phase lead of 90° relative to α(Vout−Vref). The element α(Vout−Vref) causes the delay time to be longer. Therefore, a larger element α(Vout−Vref) gives a longer delay time, thus lowering the switching frequency fsw.

Accordingly, it is important to satisfy the inequality α(Vout−Vref)<<Ic. If this inequality is satisfied, the expression (9) described above can be applied to set the switching frequency fsw to a desired frequency with adjustments to the delay time td.

As described above, according to the second embodiment, a current that flows through the smoothing capacitor C having a small parasitic resistor ESR is measured and a gain of the differential voltage output from the subtractor 5 is adjusted. With this mechanism, the switching frequency fsw can be quickly and accurately set to a desired frequency with adjustments to the delay time td, like the first embodiment.

### Third Embodiment

In a third embodiment, an inductor current is measured, different from the second embodiment.

FIG. 4 is a schematic circuit diagram of a DC-DC converter 1 according to the third embodiment. In FIG. 4, the elements common to FIG. 1 are given the same reference signs or numerals. Hereinbelow, the different points will be mainly explained.

If the load current is constant, a ripple component of the inductor current flowing through the inductor L is equal to the capacitor current. The inductor current carries a direct current component. Therefore, by removing the direct current component from the inductor current, a waveform similar to the capacitor current can be obtained.

For the reason above, provided in FIG. 4 are an inductor-current detecting part 14 for detecting an inductor current and a high-pass filter (HPF) 15 for removing a direct current component from the detected inductor current. In addition, the DC-DC converter of FIG. 4 has an amplifier 12 for multiplying a differential voltage output from the subtractor 5 by a gain, and an adder 13 for adding an output signal of the amplifier 12 and that of the high-pass filter 15.

The adder 13 adds a signal of a ripple component of the inductor current passing through the high-pass filter 15 and a differential voltage αVe gain-adjusted by the amplifier 12. A signal S obtained by addition at the adder 13 is also expressed by the expression (10). Therefore, by adjusting a gain α so that the signal of a ripple component of an inductor current passing through the bypass filter 15 becomes significantly larger than the differential voltage αVe gain-adjusted at the amplifier 12, the switching frequency fsw can be set to a desired frequency using the delay time td, like the first embodiment.

When a transformer is used as the inductor-current detecting part 14, no direct current is carried, hence the high-pass filter 15 is not required. That is, the high-pass filter 15 is not an essential part.

As described above, according to the third embodiment, a switching control signal is generated based on a detected inductor current. Therefore, the switching frequency fsw can be quickly and accurately set to a desired frequency using the delay time td, like the second embodiment.

### Fourth Embodiment

A fourth embodiment is a concrete example of the second embodiment described above.

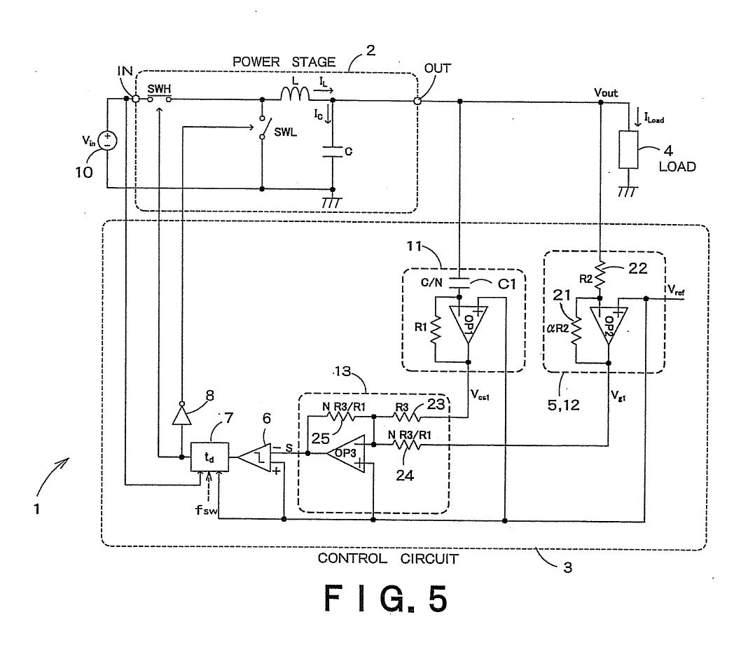

FIG. 5 is a circuit diagram of a DC-DC converter 1 according to the fourth embodiment. The circuit diagram of FIG. 5 shows the internal configuration of each component shown in FIG. 3 more in detail. In FIG. 5, a capacitor-current detecting part 11 is a differentiator including a capacitor Cl, a resister R1 and an operational amplifier OP1. The capacitor Cl is connected between the output terminal OUT of the DC-DC converter 1 and a virtual ground point of the operational amplifier OP1. The capacitance of the capacitor C1 is 1/N of the smoothing capacitor C. Flowing through the capacitor C1 is 1/N of a current flowing through the smoothing capacitor C. This current Ic/N flows through the resister R1. Therefore, an output voltage Vcs1 of the capacitor-current detecting part 11 is expressed by the following expression (11).

Vcs1=Vref −R1(Ic/N) (11)

The expression (11) is established with the condition that a direct-current output voltage Vout is equal to a reference voltage Vref. As understood from the expression (11), the output voltage Vcs1 of the capacitor-current detecting part 11 depends on a current Ic that flows through the smoothing capacitor C.

In FIG. 5, a subtractor 5 and an amplifier 12 constitute an inverting amplifier that includes a resistor 21 having a resistance αR2, a resistor 22 having a resistance R2, and an operational amplifier OP2. The resistor 22 is placed between the output terminal OUT of the DC-DC converter 1 and the inverting input terminal of the operational amplifier OP2. The resistor 21 is placed between the inverting input terminal and the output terminal of the operational amplifier OP2. Input to the non-inverting input terminal of the operational amplifier OP2 is a reference voltage Vref.

An output voltage Vg1 of the operational amplifier OP2 is expressed by the following expression (12).

Vg1=Vref−α(Vout−Vref) (12)

An adder 13 has resistors 23 to 25 and an operational amplifier OP3. The resistor 23 is placed between the inverting input terminal of the operational amplifier OP3 and the output terminal of an operational amplifier OP1. The resistor 24 is placed between the inverting input terminal of the operational amplifier OP3 and the output terminal of the operational amplifier OP2. The resistor 25 is placed between the inverting input terminal and the output terminal of the operational amplifier OP3.

An output voltage S of the adder 13 is expressed by the following expression (13).

S=Vref+α(Vout−Vref)+Ic (13)

The comparator 6 compares the output voltage S of the adder 13 and the reference voltage Vref to output a determining signal. The determining signal depends on Ic if α(Vout−Vref)<<Ic, as described above.

As described above, the circuit of FIG. 5 according to the fourth embodiment has the same advantages as the second embodiment, with comparatively simple circuit configuration.

### Fifth Embodiment

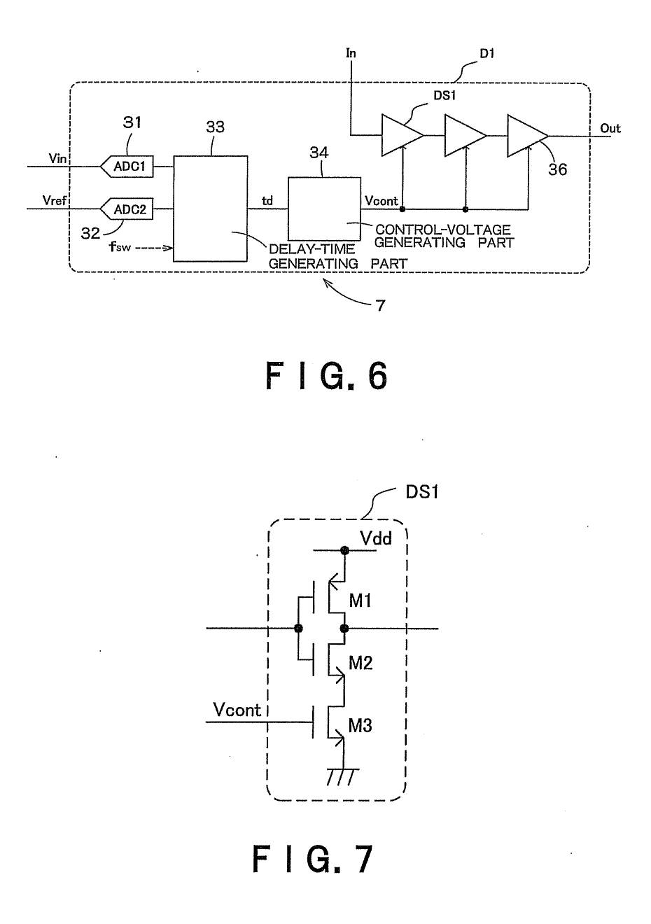

A fifth embodiment is a concrete example of the delay part 7 applicable to the first to fourth embodiments. FIG. 6 is a block diagram schematically showing the configuration of a delay part 7 according to the fifth embodiment. The delay part 7 of FIG. 6 has a first A/D converter (ADC1) 31 for converting a direct-current input voltage Vin of the DC-DC converter 1 into a digital value, a second A/D converter (ADC2) 32 for converting a reference voltage Vref into a digital value, a delay-time generating part 33, a control-voltage generating part 34, and a delay-element group 36 having a plurality of delay elements DS1 connected in cascade.

The delay-time generating part 33 receives a direct-current input voltage Vin and a reference voltage Vref as input parameters and outputs a corresponding delay time td. In some cases, the delay-time generating part 33 may receive a desired switching frequency fsw as an input parameter in addition to the direct-current input voltage Vin and the reference voltage Vref and output a corresponding delay time td.

The control-voltage, generating part 34 generates a control voltage Vcont for controlling the delay time of each of the delay elements DS1 composing of the delay-element group 36, based on the delay time td.

A delay time td to be set for obtaining a desired switching frequency fsw is expressed by the following expression (14), with Vout=Vref in the expression (9) described above.

$${t}_{d} = \frac{( {V}_{i n} - {V}_{ref} ) {V}_{ref}}{{V}_{i n}^{2}} \frac{1}{{f}_{sw}} \qquad ( 14 )$$

The delay-time generating part 33 receives a direct-current input voltage Vin and a reference voltage Vref as input parameters and outputs a delay time td for obtaining a desired switching frequency fsw based on the expression (14) described above. The delay-time generating part 33 may generate a delay time td by calculation of the expression (14) whenever the input parameters are given. For higher processing efficiency, however, it is more preferable to prepare a table of a list of a plurality of types of input parameters and the corresponding delay times td to achieve a higher processing speed and reduction of power consumption.

The switching frequency fsw may also be externally given as an input parameter. For this case, a table may be prepared which is a list of direct-current input voltages Vin, reference voltages Vref, and switching frequencies fsw, as three input parameters, and the corresponding delay times td.

The delay-time generating part 33 generates a digital value of the delay time td. Then, the control-voltage generating part 34 converts a digital delay time td into an analog control voltage Vcont for controlling a bias voltage of each delay element DS1.

It is preferable for the control-voltage generating part 34 to have a table for acquiring the control voltage Vcont using the delay time td as an input parameter in order to quickly acquire the control voltage Vcont depending on the delay time td.

FIG. 7 is a block diagram showing an example of the detailed configuration of each delay element DS1. The delay element DS1 of FIG. 7 has three transistors M1, M2, and M3 connected in cascade between a supply voltage Vdd and a ground voltage. The transistors M1 and M2 form an inverter 8 having a time constant with which an output signal falls down, that is adjusted by the transistor M3. For this adjustment, the transistor M3 operates in a linear region and functions as a variable resistor having an equivalent output resistance that varies in response to a voltage Vcont applied as a gate voltage.

As disclosed above, according to the fifth embodiment, a delay time td for obtaining a desired switching frequency fsw is generated at the delay-time generating part 33 with an externally applied direct-current input voltage Vin and reference voltage Vref as input parameters and a delay time of each delay element DS1 is adjusted based on the delay time td. Therefore, according to the fifth embodiment, it is possible to accurately adjust the switching frequency fsw to any desired frequency.

### Sixth Embodiment

A sixth embodiment is another example of the delay part 7 applicable to the first to fourth embodiments, with a purpose of more accurately controlling of the delay time of the delay part 7 than the fifth embodiment.

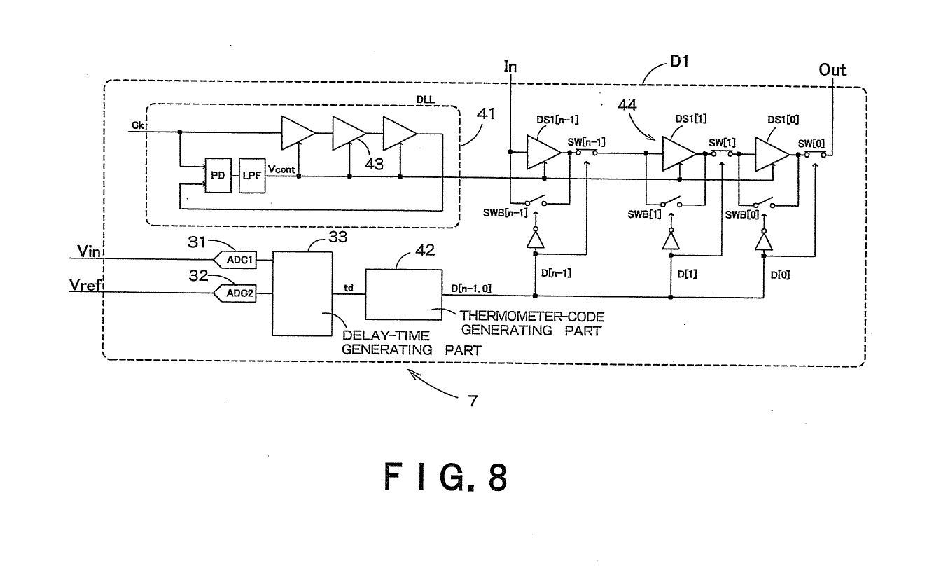

FIG. 8 is a block diagram schematically showing the configuration of a delay part 7 according to the sixth embodiment. The delay part 7 of FIG. 8 has a DLL (Delay Lock Loop) circuit 41, a first A/D converter 31 for converting a direct-current input voltage Vin of the DC-DC converter 1 into a digital value, a second A/D converter 32 for converting a reference voltage Vref into a digital value, a delay-time generating part 33, a thermometer-code generating part 42, and a delay-element group 44 having a plurality of delay elements DS1 [0:n-1] connected in cascade.

Each of the delay elements DS1 in the delay-element group 44 is provided with a bypass and a switch SWB [0:n-1] for selecting either the bypass or a delay path of each delay element DS1. Connected between successive two delay elements DS1 is a switch SW [0:n-1]. The selection of the switch SWB or SW is performed by the thermometer-code generating part 42.

The DLL circuit 41 controls a control voltage Vcont to be applied to each delay element DS1 so that one cycle of an externally input clock signal CK and the total time of a travel delay time of the delay elements DS1 become equal to each other.

The thermometer-code generating part 42 converts a delay time td of a digital value generated by the delay-time generating part 33 into an n-bit thermometer code [n-1, . . . , 0]. Each bit of the thermometer code is used for controlling each delay element DS1 in the delay-element group 44. For example, when a thermometer code D[i] of an i-th bit is “1”, a switch SW[i] of the corresponding i-th delay element DS1 is turned on whereas a switch SWB[i] thereof is turned off. Accordingly, with the values of the bits of the thermometer code, it is possible to set whether each of the delay elements DS1 is used as a signal propagation path for each delay element DS1.

The delay time of each delay element DS1 in the delay-element group 44 can be controlled by the DLL circuit 41 at almost the same accuracy as the clock signal CK. Moreover, each delay element DS1 can be controlled as to whether to delay the determining signal. Therefore, finer and more accurate delay time setting is achieved.

### Seventh Embodiment

Shown in the sixth embodiment is the example in which a desired switching frequency fsw is set at the delay-time generating part 33. In contrast, a seventh embodiment which will be described below achieves external setting of a desired switching frequency fsw.

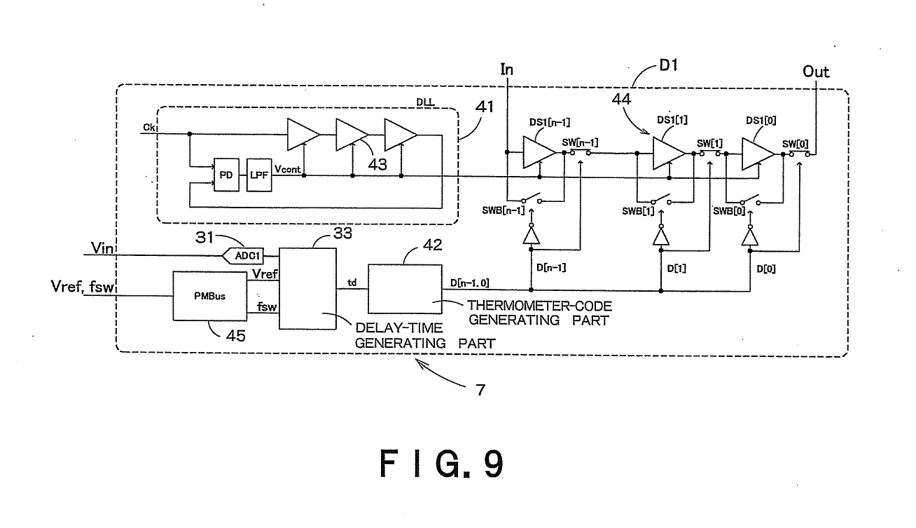

FIG. 9 is a block diagram schematically showing the configuration of a delay part 7 according to the seventh embodiment. In FIG. 9, the elements common to FIG. 8 are given the same reference numerals or signs. The different points will be mainly explained hereinbelow.

The delay part 7 of FIG. 9 has a communication interface 45 for external settings of digital values of a reference voltage Vref and a switching frequency fsw via a network, in addition to the configuration of the delay part 7 of FIG. 8. That is, in FIG. 9, a desired reference voltage Vref and switching frequency fsw are received with digital communication.

Therefore, according to the seventh embodiment, the switching frequency fsw can be dynamically adjusted in accordance with the magnitude of the load 4, with the trade off between ripples of the direct-current output voltage Vout and conversion efficiency.

Explained in the first to seventh embodiments is a voltage step-down DC-DC converter 1 for stepping down a direct-current input voltage Vin to generate a direct-current output voltage Vout. Not only that, but also the embodiments are applicable to a voltage step-up DC-DC converter 1. Moreover, explained in each embodiment is the example in which the high- and low-side switches SWH and SWL are alternately turned on and off. However, the switches SWH and SWL may not always be alternately turned on and off. That is, a term for turning off both switches may be set. Moreover, either of the switches may only be provided.

In each embodiment described above, the power stage 2 and the control circuit 3 may be integrated into a single semiconductor chip. Furthermore, for example, the control circuit 3 may be configured as a semiconductor chip with at least part of the switches SWH and SWL, the inductor L, and the smoothing capacitor C of the power stage 2 connected to the chip as external parts.

The embodiment of the present invention is not limited to the respective embodiments described above but includes a variety of modifications conceivable by parsons skilled in the art. The advantages of the present invention are also not limited to those explained above. Accordingly, various addition, changes, and partial omissions may be made without departing from the scope and spirit of the inventions derived from the accompanying claims and their equivalents.

1. A DC-DC converter control apparatus for controlling a DC-DC converter which comprises an inductor connected between an input terminal for a direct-current input voltage and an output terminal for a direct-current output voltage obtained by converting the direct-current input voltage, a capacitor connected to the inductor, and a switch configured to switch whether the direct-current input voltage is applied to the inductor,
wherein the DC-DC converter control apparatus comprises:
a subtractor configured to generate a differential voltage between the direct-current output voltage and a reference voltage;
a comparator configured to generate a determining signal that indicates determination of a polarity of the differential voltage; and
a delay part configured to delay the determining signal for a specific delay time,
wherein the switch is turned on or off based on the determining signal delayed by the delay part, and the specific delay time is decided by the direct-current input voltage, the reference voltage and a frequency for turning on or off the switch.

2. The DC-DC converter control apparatus claimed in claim 1 further comprising a current detecting part configured to detect a current that flows through the capacitor,
wherein the comparator generates the determining signal based on a signal in accordance with a current detected by the current detecting part.

3. The DC-DC converter control apparatus claimed in claim 2, wherein the current detecting part detects a current that flows through the capacitor, one end side of the capacitor being connected to the output terminal, and
the current detecting part detects a current that flows through the capacitor by differentiating the direct-current output voltage.

4. The DC-DC converter control apparatus claimed in claim 1 further comprising a current detecting part configured to detect a current that flows through the inductor,
wherein the comparator generates the determining signal based on a signal in accordance with a current detected by the current detecting part.

5. The DC-DC converter control apparatus claimed in claim 4, wherein the current detecting part detects a current that flows through the inductor,
the DC-DC converter control apparatus further comprising a high-pass filter configured to remove a direct-current signal component included in signal detected by the current detecting part,
wherein the comparator generates the determining signal based on a signal that passes through the high-pass filter.

6. The DC-DC converter control apparatus claimed in claim 1, wherein the delay part delays the determining signal for the specific delay time td that is calculated by an expression (1) below, by using the direct-current input voltage, the reference voltage, and the frequency for turning on or off the switch,
$${t}_{d} = \frac{( {V}_{i n} - {V}_{ref} ) {V}_{ref}}{{V}_{i n}^{2}} \frac{1}{{f}_{sw}} \qquad ( 1 )$$

7. The DC-DC converter control apparatus claimed in claim 1 further comprising a delay time selection table referred to using combinations of the direct-current input voltage, the reference voltage, and the frequency for turning on or off the switch as input parameters, the table outputting the specific delay time that corresponds to the input parameters,
wherein the delay part selects the specific delay time that corresponds to the input parameters from the delay time selection table and delays the determining signal for the selected delay time.

8. The DC-DC converter control apparatus claimed in claim 7, wherein the delay part includes:
a control-voltage generating part configured to generate a control voltage in accordance with a delay time output from the delay time selection table; and
a delay circuit having a plurality of delay elements connected in cascade for delaying the determining signal, a delay time of each delay element being adjustable by the control voltage.

9. The DC-DC converter control apparatus claimed in claim 1, wherein the delay part includes:
a DLL (Delay Locked Loop) circuit configured to adjust a delay time of a plurality of first delay elements connected in cascade in synchronism with a clock signal;
a delay circuit having a plurality of second delay elements connected in cascade, a delay time of the delay circuit being adjusted in synchronism with the delay time of the first delay elements;
a switching circuit configured to switch whether each of the second delay elements is used for decision of a delay time of the delay circuit;
a delay-time generating part configured to set the delay time of the delay circuit based on the direct-current input voltage and the reference voltage; and
a switching control part configured to generate a switching control signal for controlling the switching of the switching circuit based on a delay time generated by the delay-time generating part.

10. The DC-DC converter control apparatus claimed in claim 1, wherein the direct-current output voltage has a lower voltage level than the direct-current input voltage.

11. A DC-DC converter comprising:
an inductor connected between an input terminal for a direct-current input voltage and an output terminal for a direct-current output voltage obtained by converting the direct-current input voltage;
a capacitor connected to the inductor;
a switch configured to switch whether the direct-current input voltage is applied to the inductor,
a subtractor configured to generate a differential voltage between the direct-current output voltage and a reference voltage;
a comparator configured to generate a determining signal that indicates determination of a polarity of the differential voltage; and
a delay part configured to delay the determining signal for a specific delay time,
wherein the switch is turned on or off based on the determining signal delayed by the delay part, and
the specific delay time is decided by the direct-current input voltage, the reference voltage and a frequency for turning on or off the switch.

12. The DC-DC converter claimed in claim 11 further comprising a current detecting part configured to detect a current that flows through the capacitor,
wherein the comparator generates the determining signal based on a signal in accordance with a current detected by the current detecting part.

13. The DC-DC converter claimed in claim 12, wherein the current detecting part detects a current that flows through the capacitor, one end side of the capacitor being connected to the output terminal, and
the current detecting part detects a current that flows through the capacitor by differentiating the direct-current output voltage.

14. The DC-DC converter claimed in claim 11 further comprising a current detecting part configured to detect a current that flows through the inductor,
wherein the comparator generates the determining signal based on a signal in accordance with a current detected by the current detecting part.

15. The DC-DC converter claimed in claim 14, wherein the current detecting part detects a current that flows through the inductor,
the DC-DC converter control apparatus further comprising a high-pass filter configured to remove a direct-current signal component included in a signal detected by the current detecting part,
wherein the comparator generates the determining signal based on a signal that passes through the high-pass filter.

16. The DC-DC converter claimed in claim 11, wherein the delay part delays the determining signal for the specific delay time td that is calculated by an expression (2) below, by using the direct-current input voltage, the reference voltage, and the frequency for turning on or off the switch,
$${t}_{d} = \frac{( {V}_{i n} - {V}_{ref} ) {V}_{ref}}{{V}_{i n}^{2}} \frac{1}{{f}_{sw}} \qquad ( 2 )$$

17. The DC-DC converter claimed in claim 11 further comprising a delay time selection table referred to using combinations of the direct-current input voltage, the reference voltage, and the frequency for turning on or off the switch as input parameters, the table outputting the specific delay time that corresponds to the input parameters,
wherein the delay part selects the specific delay time that corresponds to the input parameters from the delay time selection table and delays the determining signal for the selected delay time.

18. The DC-DC converter claimed in claim 17, wherein the delay part includes:
a control-voltage generating part configured to generate a control voltage in accordance with a delay time output from the delay time selection table; and
a delay circuit having a plurality of delay elements connected in cascade for delaying the determining signal, a delay time of each delay element being adjustable by the control voltage.

19. The DC-DC converter claimed in claim 11, wherein the delay part includes:
a DLL (Delay Locked Loop) circuit configured to adjust a delay time of a plurality of first delay elements connected in cascade in synchronism with a clock signal;
a delay circuit having a plurality of second delay elements connected in cascade, a delay time of the delay circuit being adjusted in synchronism with the delay time of the first delay elements;
a switching circuit configured to switch whether each of the second delay elements is used for decision of a delay time of the delay circuit;
a delay-time generating part configured to set the delay time of the delay circuit based on the direct-current input voltage and the reference voltage; and
a switching control part configured to generate a switching control signal for controlling the switching of the switching circuit based on a delay time generated by the delay-time generating part.

20. The DC-DC converter claimed in claim 11, wherein the direct-current output voltage has a lower voltage level than the direct-current input voltage.
